(19) United States
(12) Patent Application Publication
(10) Pub. No.: US 2024/0223934 A1
(43) Pub. Date: Jul. 4, 2024

(54) HEADPHONE CAPABLE OF BEING BENT OUTWARD

(71) Applicant: OXTI Pte Ltd, Singapore (SG)

(72) Inventor: Chih-Feng Ho, Singapore (SG)

(21) Appl. No.: 18/092,918

(22) Filed: Jan. 3, 2023

(51) Int. Cl. H04R 1/10

(52) U.S. Cl. CPC H04R 1/105

(57) ABSTRACT

A headphone capable of being bent outward includes: a hanging rod; a support arm, provided on one side of the hanging rod; an earmuff, provided on one side of the support arm; and an external universal joint, provided between the hanging rod and support arm, allowing the support arm to be bent relative to the hanging rod. When a person wears the present invention, the support arm is bent outward, forward or backward, allowing the earmuff to be separated from the person's ear, thereby capable of hearing the conversation clearly for convenient talking.

### (a) TECHNICAL FIELD OF THE INVENTION

The present invention relates to a headphone, and more particularly to a headphone capable of being bent outward.

### (b) DESCRIPTION OF THE PRIOR ART

Taiwan Patent No. M357158, titled “foldable headphones”, as FIGS. 2 and 3 show, includes a horizontal arm, two vertical arms and two pivot arms, where each of the vertical arms is coupled pivotally to one end of the horizontal arm and has a pivot end, where the vertical arm includes an external arm and internal arm engaged with each other, the pivot arm is formed with a horizontal through hole at the pivot end of the vertical arm, and the both ends of the through hole are respectively inserted with a pivot member, allowing the pivot arm to be freely pivoted on the pivot end of the vertical arm; another end of the pivot arm is respectively laterally extended out with a clamp arm to both sides, and the two clamp arms are respectively pivoted with an earmuff that can rotate freely 360 degrees. When the headphones are folded, each of the inner arms may be first pushed into the slide groove of the vertical arm, so as to reduce the length of the vertical arm, and the pivot arms of the two vertical arms are then respectively bent inward. Thereafter, the vertical arms on the both ends of the horizontal arm is pivoted inward.

However, since the pivot arms of the two vertical arms can only be bent inward, but cannot be bent outward or swing forward or backward, so that the earmuff covers the ear when worn, and the conversation cannot be clearly heard except the headphones are taken off, and the conversation can then be clearly heard, which is very inconvenient, and there is still room for improvement.

### SUMMARY OF THE INVENTION

To overcome the above disadvantages, the present invention proposes a headphone capable of being bent outward, including: a hanging rod; a support arm, provided on one side of the hanging rod; an earmuff, provided on one side of the support arm; and an external universal joint, provided between the hanging rod and support arm, allowing the support arm to be bent relative to the hanging rod,
where the support arm includes a plurality of bend segments,
where the external universal joint includes a ball and seat, the seat is provided with a container, the ball is provided inside the container, and the outer diameter of the ball is larger than the inner diameter of the container,
where the hanging rod and support arm are elastic bodies,
where the hanging rod is provided with a telescopic element.

With the above structure, the support arm can be bent relative to the hanging rod through the external universal joint. When a person wears the present invention, the support arm is bent outward, forward or backward, allowing the earmuff to be separated from the person's ear, thereby capable of hearing the conversation clearly for convenient talking.

### BRIEF DESCRIPTION OF THE DRAWINGS

FIG. 1 is a schematic view of a headphone capable of being bent outward of the present invention;

FIG. 2 is a schematic view of the present invention when worn;

FIG. 3 is a schematic view of the present invention, where a support arm is bent outward;

FIG. 4 is a schematic view of the present invention, where the support arm is bent forward;

FIG. 5 is a schematic view of the present invention, where an earmuff is separated from the support arm;

FIG. 6 is a schematic view of the present invention, where the connecting part is a rotating shaft;

FIG. 7 is a schematic view of the present invention, where the hanging rod and support arm are elastic bodies; and

FIG. 8 is a schematic view of the present invention, where the hanging rod is provided with a telescopic element.

### DETAILED DESCRIPTION OF THE PREFERRED EMBODIMENTS

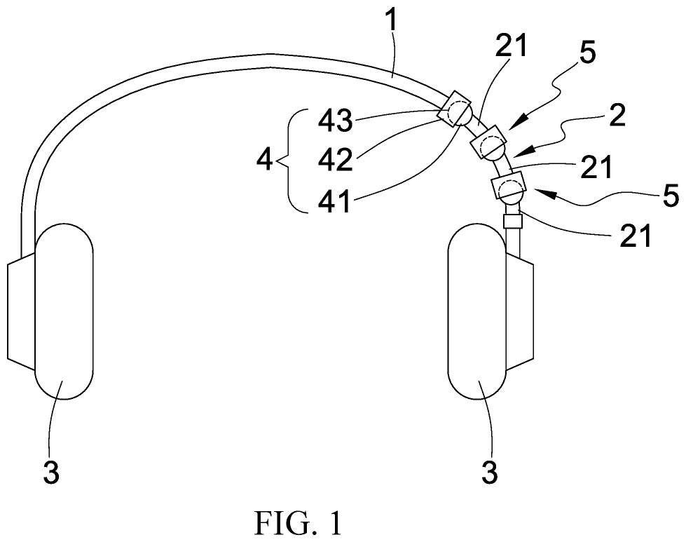

Referring to FIG. 1, a headphone capable of being bent outward of the present invention includes a hanging rod 1, a support arm 2, an earmuff 3 and an external universal joint 4.

The hanging rod 1 is roughly semi-circular arc shape.

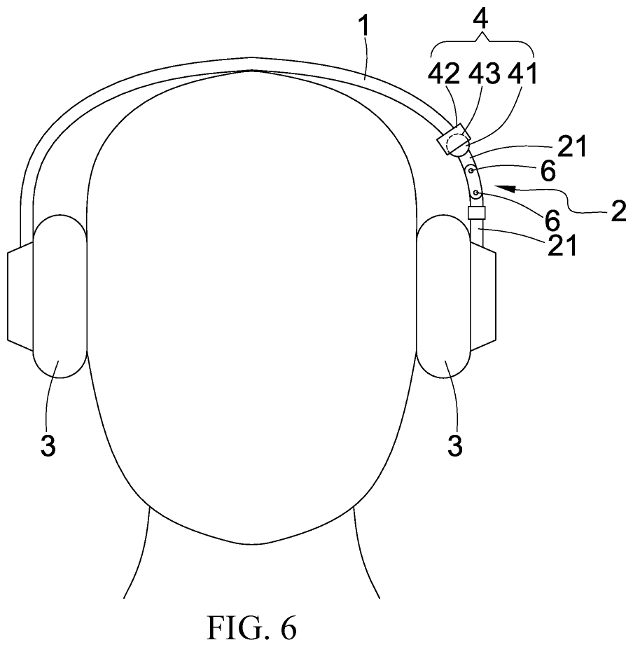

The arm 2 is provided on one side of the hanging rod 1. In the embodiment, the support arm 2 includes a plurality of bend segments 21, and at least one connecting part is provided between the plurality of bend segments 21, where the connecting part may be a universal joint 5 as shown in FIG. 1, and may also be a rotating shaft 6 shown in FIG. 6, thereby allowing the plurality of bend segments 21 to be bent relative to one another. For example, the support arm 2, as shown in FIG. 1, includes three bending sections 21, which respectively are a first bend segment, second bend segment and third bend segment, where a universal joint 5 is provided between the first bend segment and second bend segment, and a universal joint 5 between the second bend segment and third bend segment. Thus, the second bend segment can be bent relative to the first bend segment an angle (let's say 45 degrees), and the third bend segment can be bent outward relative to the second bend segment another angle (let's sat 60 degrees), thereby allowing the whole support arm 2 to have multiple bend angles.

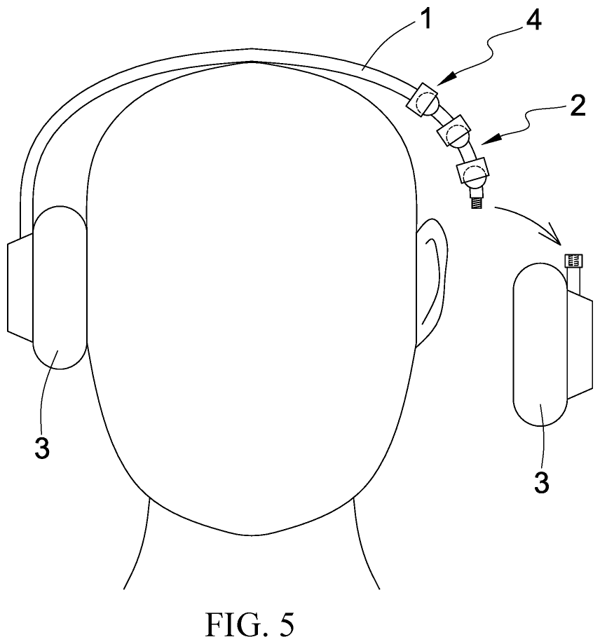

Referring to FIG. 1 again, the earmuff 3 is provided on one side of the support arm 2. Referring to FIG. 5, the earmuff 5 can be combined with or separated from the support arm 2. When the earmuff 3 is damaged, it can be detached from the support arm 2 for replacement, and there is no need to scrap the whole headphones, which effectively avoids the waste of resources.

When the external universal joint 4 is provided between the hanging rod 1 and support arm 2, allowing the support arm 2 to be bent relative to the hanging rod 1. The external universal joint 4 may include a ball 41 and seat 42, where the seat 42 is provided with a container 43, and the ball 41 inside the container 43, the outer diameter of the ball 41 is larger than the inner diameter of the container 43, forming a tight fit. The tight fit means that the ball 41 is completely tightly combined with the inner wall of the container 43, which makes the ball 41 not rotated at will, and the ball 41 can be rotated relative to the container 43 only under the action of a certain external force. Upon implementation, the hanging rod 1 may be connected with the ball 41 of the external universal joint 4, and the support arm 2 the seat 42 of the external universal joint 4. Vice versa, the hanging rod 1 may also be connected with the seat 42 of the external universal joint 4, and the support arm 2 the ball 41 of the external universal joint 4. In the present invention, the external universal joint 4 here is ball universal joint, but the present invention is not so limited, another universal joint may also be used.

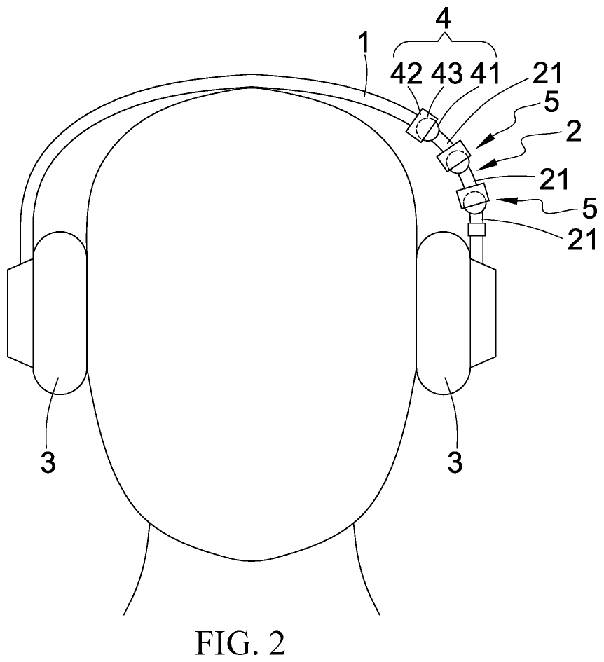

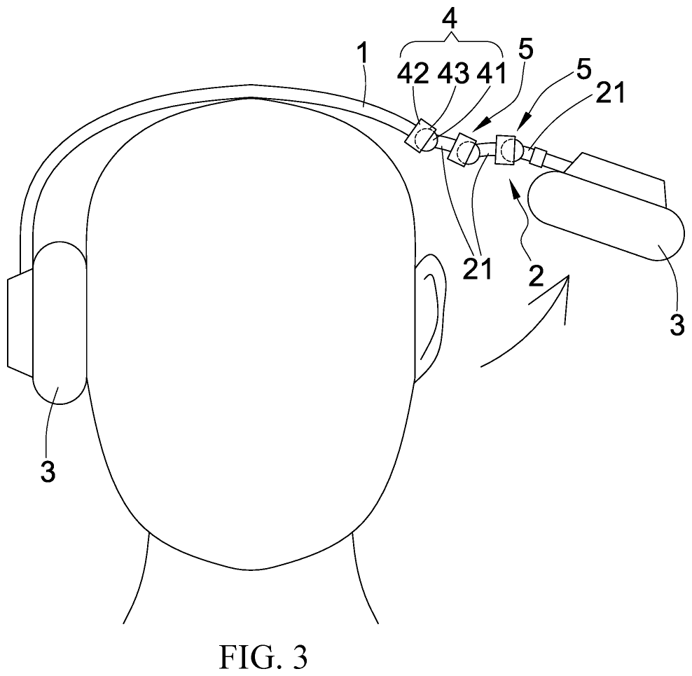

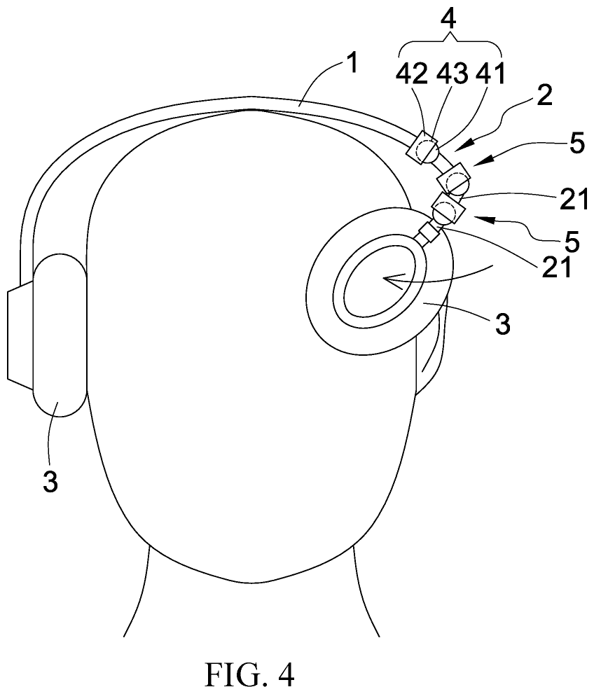

Referring to FIG. 2, when the present invention is worn, the hanging rod 1 is first placed on a user's head, and the earmuff 3 is then covered on the ear. Referring to FIG. 3, when the user is in a conversion, they can bend the support arm 2 outward; since the support arm 2 is connected to the hanging rod 1 through the external universal joint 4, the support arm 2 can be rotated relative to the container 43 through the ball 41 of the external universal joint 4, allowing the support arm 2 to be bent and then the earmuff 3 to be separated from the ear to not more cover the ear, so that the user can then clearly hear the conversation. Referring to FIG. 4, the user can also bend the support arm 2 forward or backward, depending on the actual needs. In addition, the support arm 2 includes the plurality of bend segments 21, and the plurality of bend segments 21 can still be bent relative to one another.

Whereby, the support arm 2 can be rotated relative to the hanging rod 1 through the external universal joint 4, allowing the support arm 2 to be bent outward, forward or backward to separate from the ear when the headphone of the present invention is worn, so that the conversation can be clearly heard. Namely, when the present invention is worn, only the support arm 2 on one side needs to be lifted up together with the earmuff 3 if the user wants to have conversation with other person without needing to lift the whole headphones away from the head, which is very convenient. Furthermore, the present invention also has the effect of shrinking and reducing the volume; the support arm 2 is rotated relative to the hanging rod 1, and the bent angle of the support arm 2 is adjusted, further allowing the whole volume to be reduced, being convenient for storage.

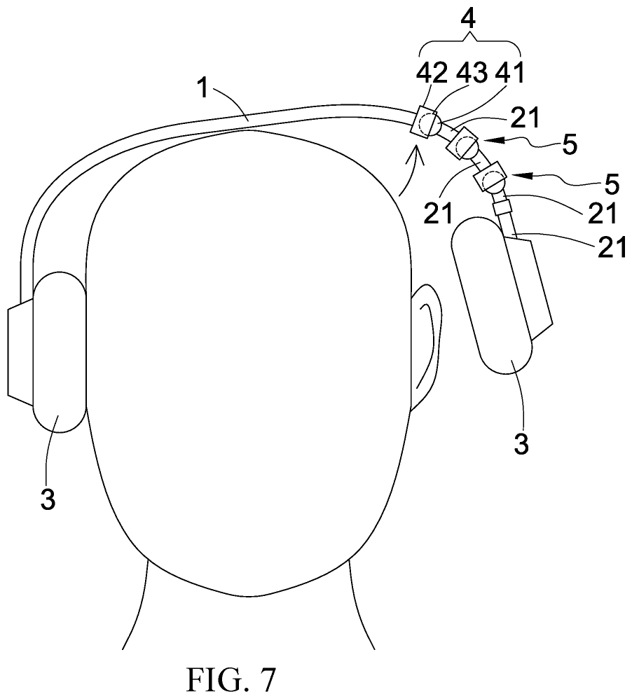

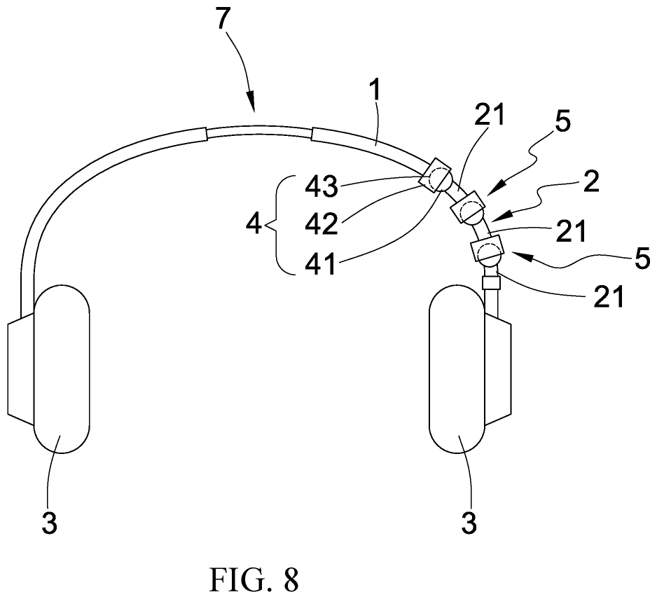

Further referring to FIG. 7, the hanging rod 1 and support arm 2 are elastic bodies, made of material having elastic restoring force or plastic deformation, capable of allowing the support arm 2 to recover the deformation after the bending. Referring to FIG. 8, the hanging rod 1 is provided with a telescopic element 7, which can be a flexible material or a telescopic sleeve with adjustable length, thereby using the telescopic element 7 to adjust the length of the hanging rod 1 according to the size of the user's head, so as to conform to personal needs.

I claim:

1. A headphone capable of being bent outward, comprising
a hanging rod;
a support arm, provided on one side of said hanging rod;
an earmuff, provided on one side of said support arm; and
an external universal joint, provided between said hanging rod and support arm, allowing said support arm to be bent relative to said hanging rod.

2. The headphone according to claim 1, wherein said support arm comprises a plurality of bend segments.

3. The headphone according to claim 1, wherein said external universal joint comprises a ball and seat, said seat is provided with a container, said ball is provided inside said container, and the outer diameter of said ball is larger than the inner diameter of said container.

4. The headphone according to claim 1, wherein said hanging rod and support arm are elastic bodies.

5. The headphone according to claim 1, wherein said hanging rod is provided with a telescopic element.
